(19) United States
(12) Patent Application Publication
(10) Pub. No.: US 2009/0316607 A1
(43) Pub. Date: Dec. 24, 2009

(54) Group Call Notification Method and Mobile Station

(75) Inventor: Masaru Fukushima, Yokohama (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/298,738

(22) PCT Filed: Apr. 26, 2007
(86) PCT No.: PCT/JP2007/059078

§ 371 Date: Apr. 8, 2009

(30) Foreign Application Priority Data
Apr. 27, 2006 (JP) 2006-124527

(51) Int. Cl. H04L 12/16

(52) U.S. Cl. 370/260; 455/466

(57) ABSTRACT

A group call notification method according to the present invention includes the steps of: managing information on a member participating in the group call among the specified members when a plurality of members are specified and the group call is started; and when receiving an inquiry about a member participating in the group call from a member not participating in the group call among the specified members, notifying the member who has made the inquiry of information on the member participating in the group call on the basis of the managed information.

### TECHNICAL FIELD

The present invention relates to a group call notification method and a mobile station that are used in a group call performed through a server connected to a packet switching network. The group call is performed by a group including an originating mobile station that is a mobile station on an originating side, and specified mobile stations that are a plurality of mobile stations specified by the originating mobile station, as an initial group.

### BACKGROUND ART

Conventionally, a “group call” has been known in which voice communication is performed through a packet switching network by a group formed of an originating mobile station and a plurality of mobile stations specified by the originating mobile station (hereinafter, specified mobile stations), as an initial group.

In the group call, a SIP server connected to the packet switching network performs call control of each mobile station participating in the group call, using the SIP (Session Initiation Protocol, RFC3261).

Specifically, the originating mobile station transmits, to the SIP server, a call request (INVITE) for the plurality of specified mobile stations.

Here, in order for each specified mobile station to receive the call request (INVITE) from the originating mobile station, from the SIP server, each specified mobile station needs to log in to the SIP server (registration). However, each specified mobile station is not always logging in to the SIP server.

Then, when the SIP server receives the call request (INVITE) for the specified mobile stations from the originating mobile station, the SIP server transmits a transmission request of SMS (Short Message Service) information to an SMS server connected to a line switching network, the SMS information requesting each specified mobile station to log in to the SIP server. Subsequently, the SMS server transmits the SMS information for requesting a login to the SIP server to each specified mobile station.

The specified mobile station that has received the SMS information logs in to the SIP server, thereby to receive the call request (INVITE) from the originating mobile station. By receiving the call request (INVITE) from the originating mobile station, the specified mobile station can receive information on each mobile station included in the initial group, and can figure out each mobile station.

Thus, once the originating mobile station transmits the call request (INVITE) specifying plurality of mobile stations to the SIP server, the group call is started. Moreover, the specified mobile station that has received the call request (INVITE) from the originating mobile station participates in the group call by responding (transmitting 200 OK) to the SIP server.

On the other hand, the specified mobile station that is included in the initial group but does not participate in the group call (hereinafter, “non-participating mobile station”) and the mobile station that is not included in the initial group can participate in the group call halfway, when the mobile station that participates in the group call (hereinafter, “participating mobile station”) invites these mobile stations to participate in the group call halfway.

Specifically, by transmitting the call request (INVITE), the participating mobile station invites the non-participating mobile station and the mobile station not included in the initial group to participate in the group call halfway.

### DISCLOSURE OF THE INVENTION

However, when the non-participating mobile station is the specified mobile station that is located out of an area of the line switching network and cannot receive the SMS information, the non-participating mobile station does not notice that the group call has started of the initial group including the non-participating mobile station.

In addition, in a case where the non-participating mobile station is the specified mobile station that is located out of an area of the packet switching network and cannot log in to the SIP server, even when the non-participating mobile station notices that the group call has started of the initial group including the non-participating mobile station, the non-participating mobile station cannot figure out other mobile station included in the initial group other than the non-participating mobile station.

Therefore, when the non-participating mobile station is located out of the area of the line switching network and out of the area of the packet switching network, naturally, the non-participating mobile station cannot figure out the participating mobile station of the group call of the initial group including the non-participating mobile station, either.

Furthermore, when the non-participating mobile station is the specified mobile station that receives the call request (INVITE) from the originating mobile station but does not respond (transmit 200 OK), that is, when the non-participating mobile station is located within the area of the line switching network and the area of the packet switching network, the non-participating mobile station can figure out all the mobile stations included in the initial group. However, if the non-participating mobile station does not participate in the group call started by responding to the call request (INVITE), the non-participating mobile station cannot figure out the participating mobile station of this group call.

Particularly, in the case of the system where an invitation from the participating mobile station allows the non-participating mobile station and the mobile station not included in the initial group to participate in the group call halfway, there has been a problem that even in the group call including the non-participating mobile station in the initial group, the non-participating mobile station cannot figure out the participating mobile station when participating in this group call halfway.

Then, the present invention is made in consideration of the above-mentioned points. An objective of the present invention is to provide a group call notification method and a mobile station that allows even a non-participating mobile station that does not participate in a group call to figure out a participating mobile station in the group call of an initial group includes the non-participating mobile station.

A first aspect of the present invention is summarized as a group call notification method comprising the steps of: managing, when a plurality of members are specified and a group call is started, information on a member participating in the group call among the specified members; and notifying, when receiving an inquiry about a member participating in the group call from a member not participating in the group call among the specified members, the member who has made the inquiry of information related to the member participating in the group call on the basis of the managed information.

According to this aspect, even the member not participating in the group call (non-participating mobile station) can acquire the information related to the member (participating mobile station) participating in the group call where the non-participating mobile station is specified.

A second aspect of the present invention is summarized as a mobile station including: a transmitter configured to transmit an inquiry request that inquires whether a group call where the mobile station is specified is started, using identification information that identifies the mobile station; an acquiring unit configured to acquire information related to the group call where the mobile station is specified, in response to the inquiry request transmitted by the transmitter; and a display unit configured to display the information that is related to the group call where the mobile station is specified, and is acquired by the acquiring unit.

In the second aspect of the present invention, when a group call where the mobile station is specified is started, the acquiring unit may acquire the information on a member participating in the group call as the information related to the group call where the mobile station is specified; and the display unit may display the information on the member participating in the group call, the information being acquired by the acquiring unit.

In the second aspect of the present invention, the identification information that identifies the mobile station may be any one of a telephone number, an-email address, and an IP address.

In the second aspect of the present invention, the mobile station further includes a storage unit configured to store information of a received call history, and the acquiring unit so may store the information on the group call where the mobile station is specified in the storage unit as the received call history, the information being acquired in response to the inquiry request.

In the second aspect of the present invention, the mobile station may include a calling unit configured to call by generating a start request of a new group call, using the information on the group call where the mobile station is specified, the information being stored in the storage unit as the received call history.

According to the present invention, it is possible to provide a group call notification method and a mobile station can be provided that allows even a non-participating mobile station that does not participate in a group call to figure out a participating mobile station of the group call that includes the non-participating mobile station in an initial group.

### BRIEF DESCRIPTION OF THE DRAWINGS

FIG. 1 is an overall schematic configuration diagram of a radio communication network according to an embodiment of the present invention.

FIG. 2 is a block configuration diagram of a SIP server according to the embodiment of the present invention.

FIG. 3 is a diagram showing an example of a group call management DB according to the embodiment of the present invention.

FIG. 4 is a block configuration diagram of a mobile station according to the embodiment of the present invention.

FIG. 5 is a block configuration diagram of a CPU of the mobile station according to the embodiment of the present invention.

FIG. 6 is a sequence diagram showing operation in which the mobile station starts a group call in the radio communication network according to the embodiment of the present invention.

FIG. 7 is a sequence diagram showing the operation in which the mobile station starts the group call in the radio communication network according to the embodiment of the present invention.

FIG. 8 is a diagram showing a display screen of the mobile station according to the embodiment of the present invention.

### BEST MODE FOR CARRYING OUT THE INVENTION

### Schematic Configuration of Radio Communication Network

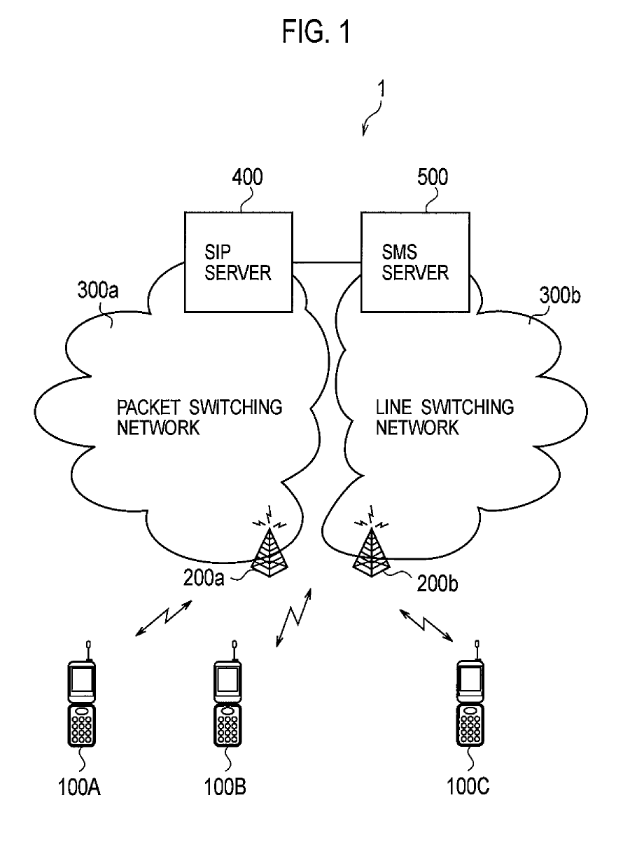

With reference to FIG. 1, a schematic configuration of a radio communication network 1 according to the present embodiment will be described.

In the specification, a group call includes mainly voice communication among a plurality of terminals and communication in which the voice communication and non-voice communication such as an image are united. The examples of these communications are the PTT (Push-to-Talk) that is a kind of the VoIP (Voice over IP) communication, TV phone meeting, etc.

As shown in FIG. 1, the radio communication network 1 includes a SIP server 400 and an SMS server 500. A plurality of mobile stations 100 (mobile stations 100A to 100C) according to the present embodiment are configured to be connectable to the SIP server 400 through a base station 200a and a packet switching network 300a. The plurality of mobile stations 100 (mobile stations 100A to 100C) are configured to be connectable to the SMS server 500 through a base station 200b and a line switching network 300b.

In the packet switching network 300a, a group including one mobile station 100 (originating mobile station) and other mobile stations 100 (specified mobile stations) specified by the one mobile station 100 is formed as an initial group, and a group call by a plurality of mobile stations 100 (members) is performed through the SIP server 400.

The group call is started when one mobile station 100 (originating mobile station) transmits a call request (INVITE) to the other mobile stations 100 (specified mobile stations) specified by the one mobile station 100 to the SIP server 400, and the other mobile stations 100 (specified mobile stations) respond to the call request (INVITE).

Hereinafter, in the present embodiment, the mobile station 100A is the originating mobile station (originating mobile station) of the group call, and the mobile stations 100B and 100C are the mobile stations (specified mobile stations) specified by the originating mobile station. In other words, the group call is performed where the mobile stations 100A to 100C are initial group mobile stations included in the initial group.

Additionally, description will be given when the mobile stations 100A and 100B are participating mobile stations that are the mobile stations that participate in the group call, and the mobile station 100C is a non-participating mobile station that does not participate in the group call.

The SMS server 500 connected to the line switching network 300b provides message service (short message service). The SMS server 500 has a function to allow transmission of SMS information to the mobile stations 100A to 100C and reception of SMS information from the mobile stations 100A to 100C through the line switching network 300b.

Here, the SMS information is, for example, information (push type SMS (login request)) or the like that requests a login to the SIP server 400.

From the SIP server 400, the SMS server 500 receives a transmission request (SMS transmission request) for the SMS information that requests a login to the SIP server 400.

### (Configuration of SIP Server)

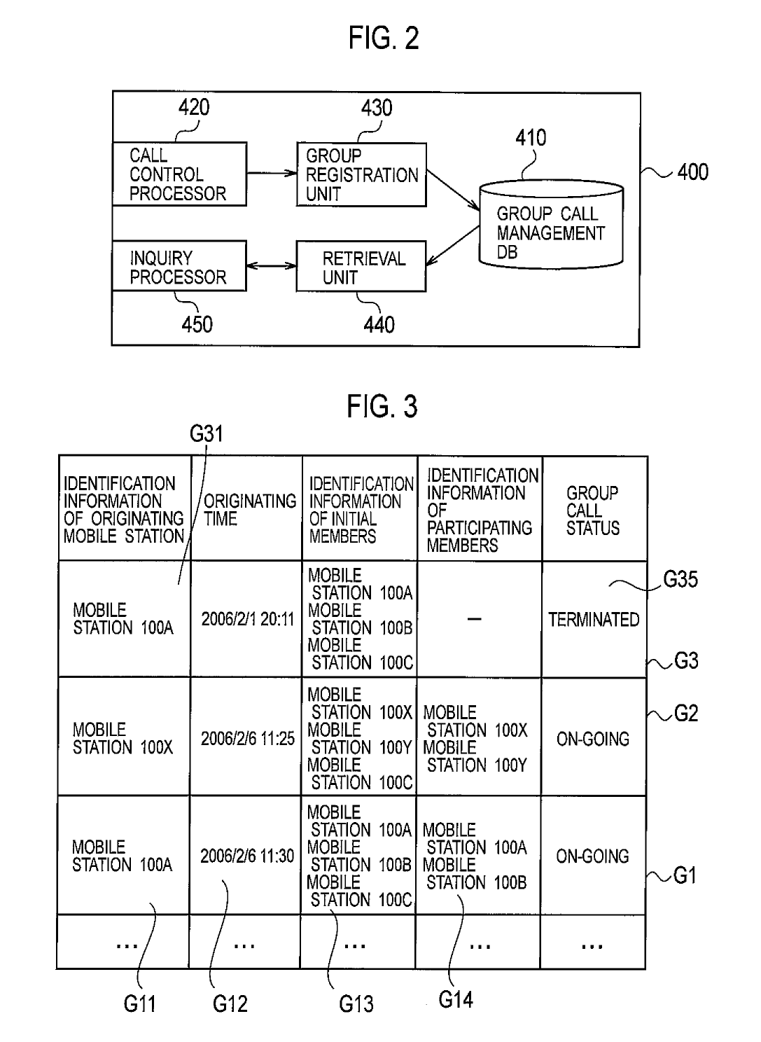

With reference to FIG. 2, a configuration of the SIP server 400 used in the radio communication network 1 will be described.

As shown in FIG. 2, the SIP server 400 includes a group call management DB 410, a call control processor 420, a group registration unit 430, a retrieval unit 440, and an inquiry processor 450.

Hereinafter, parts concerning the present invention will be mainly described. Therefore, note that the SIP server 400 may include logical blocks (power supply unit, etc.) that are necessary when implementing function as the SIP server 400 but that are not shown or are omitted in the explanation.

The group call management DB 410 stores information shown in FIG. 3 as group call information for managing the mobile stations 100A to 100C that perform the group call.

Here, the group call information are generically referred to identification information of the originating mobile station, originating time (time of start), identification information of the initial members, identification information of the participating members, and the group call status that are associated with each other and stored in the group call management DB 410.

The group call management DB 410 associates with each other and stores the identification information of the originating mobile station, the originating time, the identification information of the initial members, the identification information of the participating members, and the group call status, as shown in FIG. 3.

Here, the originating time (time of start) is the time at which the originating mobile station (for example, mobile station 100A) transmits the call request (INVITE) to the specified mobile stations (for example, mobile stations 100B and 100C), i.e., time at which the originating mobile station and the specified mobile stations are formed as an initial group and the group call starts. The group call is uniquely specified by the identification information of the originating mobile station and the originating time.

The identification information of the initial members is the identification information of the initial group mobile stations that are the mobile station included in the initial group (for example, mobile stations 100A to 100C). The identification information of the participating members is the identification information of the participating mobile stations (for example, mobile stations 100A and 100B).

The above-mentioned identification information of the originating mobile station, the identification information of the initial members, the identification information of the participating mobile stations are, for example, a telephone number, an E-mail address, or an IP address acquired through a login processing to the SIP server.

The group call status is the status that identifies whether the group call is continuing or terminated.

The call control processor 420 performs call control of the mobile stations 100A to 100C that perform the group call. Specifically, the call control processor 420 transmits SIP information to the mobile stations 100A to 100C and receives the SIP information from the mobile stations 100A to 100C.

Here, the SIP information is the call request (INVITE) from the originating mobile station to the specified mobile station, the call request (INVITE) from the participating mobile station to the non-participating mobile station, a transmission request (INFO) for the call request (INVITE) to the originating mobile station, etc. In addition, the SIP information is various messages used in the SIP (100 Trying, 180 Ringing, 200 OK, ANSEWER, etc.).

The call request (INVITE) from the originating mobile station to the specified mobile station includes the identification information of the originating mobile station, the above-mentioned originating time, and the identification information of the initial members.

From the originating mobile station, the call control processor 420 receives the call request (INVITE) to the specified mobile station. Then, the call control processor 420 transmits a transmission request (SMS transmission request) for the SMS information to the SMS server 500, the transmission request (SMS transmission request) requesting a login to the SIP server 400.

The group registration unit 430 adds, deletes, or updates the group call information in the group call management DB 410.

Specifically, the group registration unit 430 associates the identification information of the originating mobile station, the originating time, and the identification information of the initial members with one another, and stores them in the group call management DB 410. The above three pieces of information are included in the call request (INVITE) received by the call control processor 410, the call request (INVITE) being the request from the originating mobile station to call the specified mobile station. At this time, the group registration unit 430 registers the identification information of the originating mobile station in the group call management DB 410 as the identification information of the participating members.

When the call control processor 420 receives a response (200 OK) to the call request (INVITE) from the originating mobile station from the specified mobile station, the group registration unit 430 adds the identification information of the specified mobile station to the above-mentioned identification information of the participating members.

Similarly, when the call control processor 420 receives a response (200 OK) to the call request (INVITE) to the non-participating mobile station, performed by the participating mobile station, from the non-participating mobile station, the group registration unit 430 adds the identification information of the non-participating mobile station, which has responded to the call request (INVITE), to the above-mentioned identification information of the participating members.

When the call control processor 420 receives BYE from the participating mobile station, from the above-mentioned identification information of the participating members, the group registration unit 430 deletes the identification information of the mobile station that has withdrawn.

With reference to the group call management DB 410, from the identification information of the initial members, the retrieval unit 440 retrieves the identification information that coincides with the identification information of the non-participating mobile station received by the inquiry processor 450, which will be described later. In the group call management DB 410, the retrieval unit 440 can extract the identification information of the originating mobile station, the originating time, the identification information of the initial members, the identification information of the participating members, and the group call status that are associated with the identification information that coincides with that of the non-participating mobile station.

From the non-participating mobile station (mobile station 100C), the inquiry processor 450 receives an inquiry request for inquiring the information on the group call that includes the non-participating mobile station (mobile station 100C) as the initial group. The inquiry request includes the identification information of the non-participating mobile station.

The inquiry processor 450 transmits the group call information extracted by the retrieval unit 440 to the non-participating mobile station (mobile station 100C).

In the present example, the group call management DB 410, the call control processor 420, the group registration unit 430, the retrieval unit 440, and the inquiry processor 450 are described as the function of the SIP server 400, but not limited to this. The above-mentioned components may be configured in combination with other server.

### (Configuration of Mobile Station)

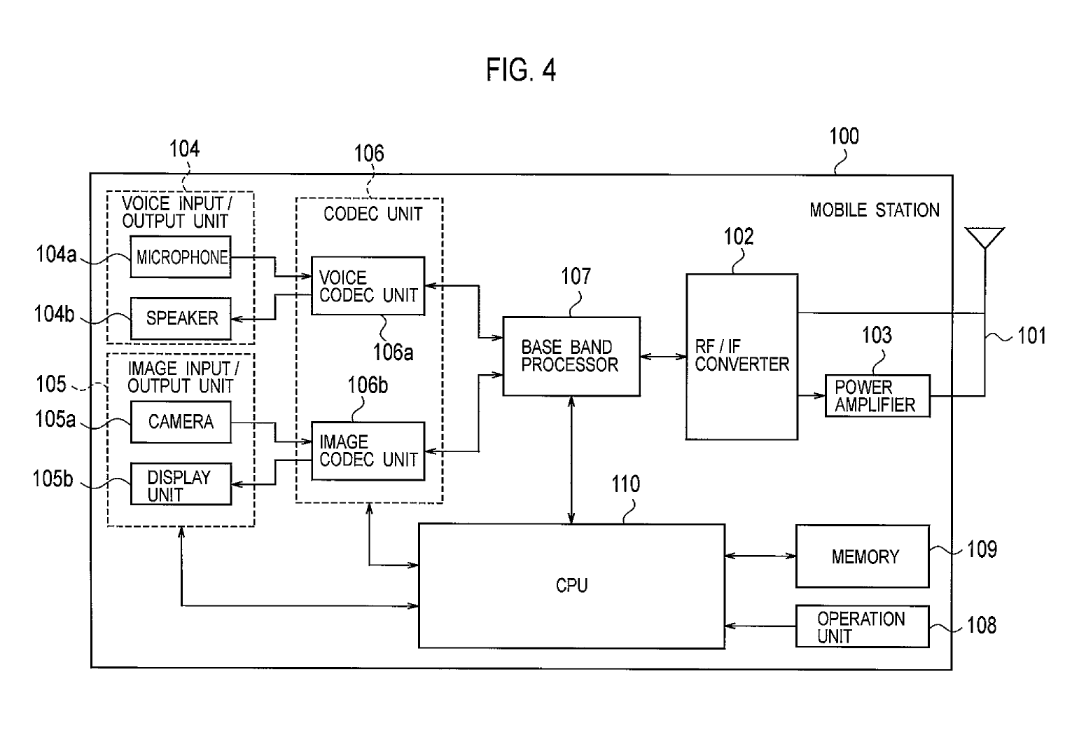

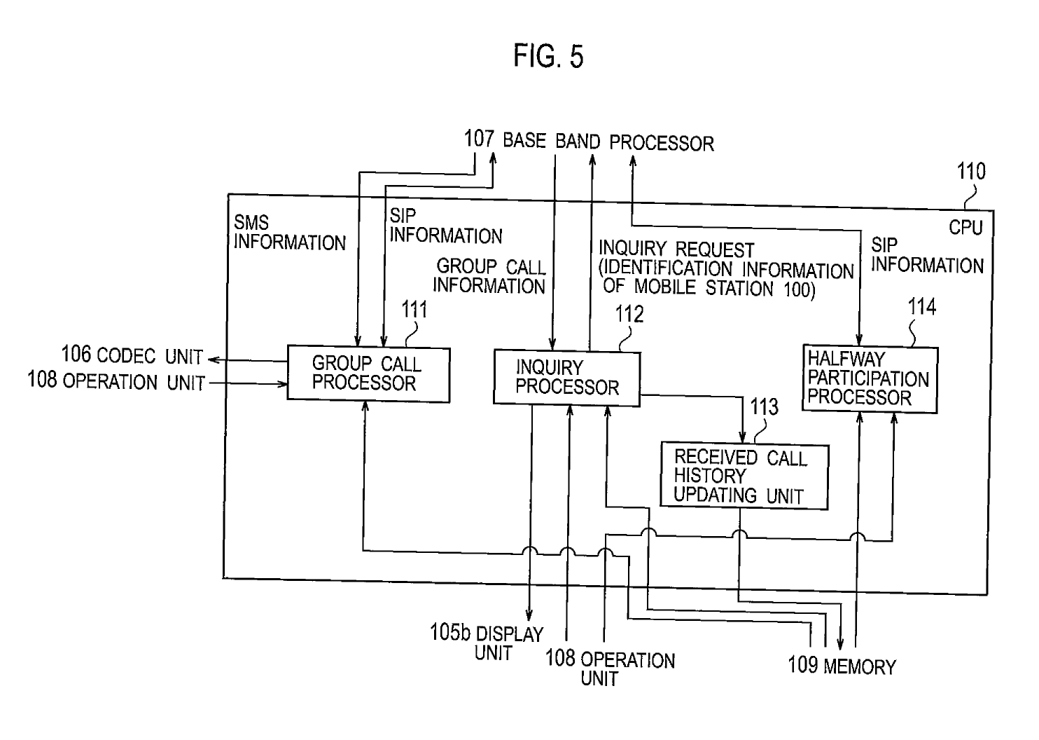

With reference to FIGS. 4 and 5, a configuration of the mobile station 100 used in the radio communication network 1 will be described.

Since the mobile station 100A to the mobile station 100C have the same configuration, these are generically referred to as the mobile station 100 and described below.

As shown in FIG. 4, the mobile station 100 has an antenna 101, an RF/IF converter 102, a power amplifier 103, a voice input/output unit 104, an image input/output unit 105, a codec unit 106, a base band processor 107, an operation unit 108, a memory 109, and a CPU 110.

The antenna 101 receives a signal (received signal) transmitted by the base stations 200a and 200b respectively connected to the packet switching network 300a and the line switching network 300b. The antenna 101 also transmits a signal (transmission signal) to the base stations 200a and 200b respectively connected to the packet switching network 300a and the line switching network 300b.

The RF/IF converter 102 converts a frequency (RF (Radio Frequency)) of the received signal received by the antenna 101 into a frequency (IF (Intermediate Frequency)) treated by the base band processor 107. The RE/IF converter 102 also converts a frequency (intermediate frequency (IF)) of the transmission signal acquired from the base band processor 107 into a frequency (radio frequency (RF)) used in the radio communication. The RF/IF converter 102 inputs the transmission signal, which is converted into the radio frequency (RF), into the power amplifier 103.

The power amplifier 103 amplifies the transmission signal acquired from the RF/IF converter 102, and inputs the amplified transmission signal into the antenna 101.

The voice input/output unit 104 has a microphone 104a that collects the voice, and a speaker 104b the outputs the voice. The microphone 104a inputs a voice signal into the codec unit 106 on the basis of the collected voice. The speaker 104b outputs the voice on the basis of the voice signal acquired from the codec unit 106.

The image input/output unit 105 has a camera 105a that shoots a photographic subject, and a display unit 105b that displays characters, images, etc. The camera 105a inputs an image signal into the codec unit 106 on the basis of the captured image (static image or dynamic image). The display unit 105b displays the image on the basis of the image signal acquired from the codec unit 106. The display unit 105b displays the characters, or the like that are inputted using the operation unit 108.

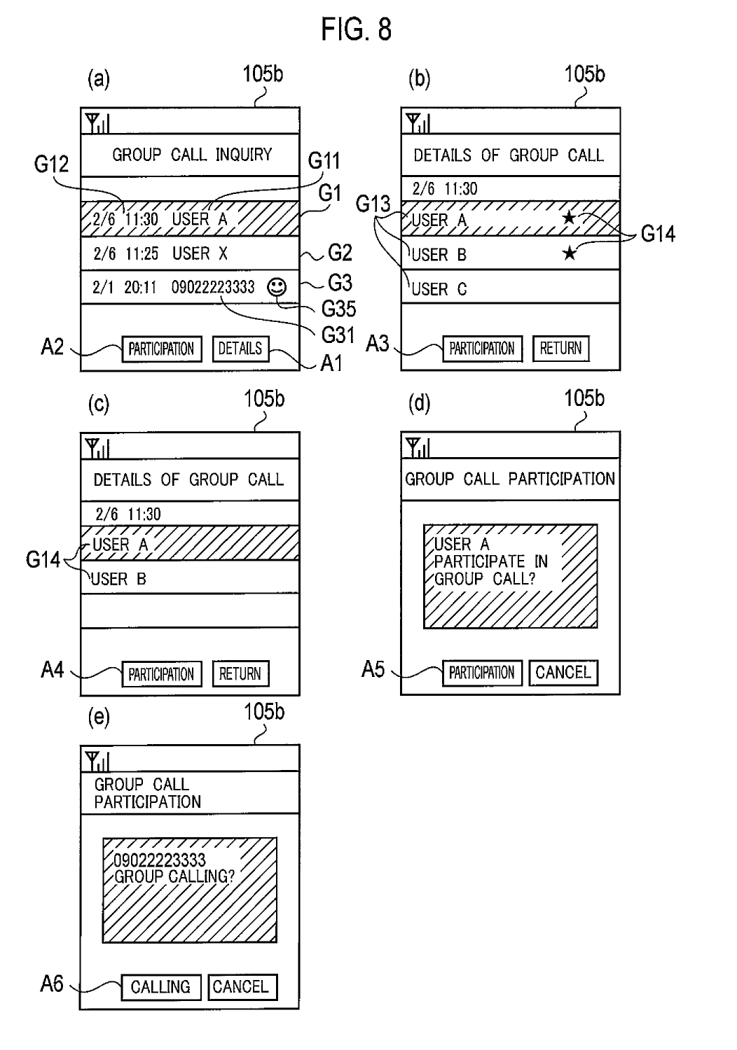

In the present embodiment, on the basis of an instruction of the CPU 110, the display unit 105b displays the group call information received from the SIP server 400 (at least, whether the group call where the mobile station is specified exists (starts)), as shown in FIG. 8.

The codec unit 106 has a voice codec unit 106a that encodes and decodes the voice signal in accordance with a predetermined coding mode (for example, EVRC), and an image codec unit 106b that encodes and decodes the image signal in accordance with a predetermined coding mode (for example, MPEG (Moving Picture coding Experts Group)-4, etc.).

The voice codec unit 106a encodes the voice signal acquired from the voice input/output unit 104 and decodes the voice signal acquired from the base band processor 107. The image codec unit 106b encodes the image signal acquired from the image input/output unit 105 and decodes the image signal acquired from the base band processor 107.

The base band processor 107 modulates the transmission signal and demodulates the received signal in accordance with a predetermined modulation technique (BPSK (Binary Phase Shift Keying), QPSK (Quadrature Phase Shift Keying), etc.). Specifically, the base band processor 107 modulates base band signals acquired from the codec unit 106, such as the voice signal and the image signal to input the modulated base band signal (transmission signal) into the RF/IF converter 102. The base band processor 107 also demodulates the received signal acquired from the RF/IF converter 102, to input the demodulated received signal (base band signal) into the codec unit 106.

The base band processor 107 modulates information (SMS information, SIP information, and inquiry request) generated by the CPU 110, to input the modulated information (transmission signal) into the RF/IF converter 102. The base band processor 107 also demodulates the received signal acquired from the RF/IF converter 102 to input the demodulated received signal (SMS information, SIP information, and group call information) into the CPU 110.

The operation unit 108 is a group of keys formed of input keys for inputting characters, numerals, or the like, a calling key for starting the group call, an answering key for answering the received call (call), an inquiry key for inquiring the group call, etc. When each key is pressed down, the operation unit 108 inputs an input signal corresponding to the pressed key into the CPU 110. Inquiry can be treated by a soft key, or the like.

The memory 109 stores a program for controlling operation of the mobile station 100, and various data such as a received call history, an address book, etc. The memory 109 is formed of, for example, a flash memory that is a nonvolatile semiconductor memory, an SRAM (Static Random Access Memory) that is a volatile semiconductor memory, etc.

Specifically, the memory 109 stores the identification information of the mobile station 100. Here, the identification information of the mobile station 100 is the telephone number of the mobile station 100, the E-mail address of the mobile station 100, the IP address of the mobile station 100 acquired through a login processing to the SIP server, etc.

The memory 109 stores the received call history. The memory can also be formed of a detachable type memory.

The group call information is stored in the received call history in a way that the received identification information of the originating mobile station, the originating time, the identification information of the initial members, the identification information of the participating members, and the group call status are associated with each other, similarly to the configuration of the group call management DB 410 of the SIP server 400 described with reference to FIG. 3.

The received call history is updated on the basis of the call request (INVITE) from the originating mobile station, the call request (INVITE) being received from the SIP server 400. The received call history is updated on the basis of the group call information received from the SIP server 400.

The CPU 110 controls the operation of the mobile station 100 (image input/output unit 105, codec unit 106, base band processor 107, etc.) in accordance with the program stored in the memory 109.

FIG. 5 is a block diagram showing the configuration of the CPU 110 according to the present embodiment.

As shown in FIG. 5, the CPU 110 has a group call processor 111, an inquiry processor 112, a received call history updating unit 113, and a halfway participation processor 114.

The group call processor 111 performs processing concerning the group call in accordance with the SIP.

For example, the group call processor 111 performs a processing to answer a call from another mobile station 100 in accordance with the input signal acquired from the operation unit 108, and so on. Specifically, the group call processor 111 generates the SIP information (180 Ringing, 200 OK, etc.) in accordance with the SIP information (call request (INVITE) from the originating mobile station) acquired from the base band processor 107, and inputs the generated SIP information into the base band processor 107.

The group call processor 111 performs a processing to call the initial members of a terminated group call on the basis of the received call history stored in the memory 109 (so-called redial) while the mobile station 100 serves as the originating mobile station.

Specifically, on the basis of the received call history stored in the memory 109, the group call processor 111 generates SIP information (call request (INVITE) for the initial members of the terminated group call, that is, a start request for a new group call where the initial members of the terminated group call are the members). Then, the group call processor 111 inputs the generated SIP information into the base band processor 107.

The group call processor 111 acquires the SMS information (SMS (login request)) from the base band processor 107, the SMS information (SMS (login request)) being received from the SMS server 500. The group call processor 111 also performs a login processing (registration processing) in the SIP server 400.

The inquiry processor 112 performs a processing to inquire the information on the group call that includes the mobile station 100 in the initial group.

Specifically, on the basis of the input signal from the operation unit 108, the inquiry processor 112 generates the inquiry request that requests to acquire the information on the group call (at least, whether the group call where the mobile station is specified exists (starts)), the group call including the mobile station 100 in the initial group. The inquiry processor 112 includes the identification information of the mobile station 100 in the inquiry request, the identification information of the mobile station 100 being stored in the memory 109. The inquiry processor 112 inputs the generated inquiry request into the base band processor 107.

The inquiry request is transmitted to the SIP server 400 through the packet switching network 300a as a message (INFO message, etc.) used in the SIP.

The inquiry processor 112 acquires the group call information transmitted by the SIP server 400 from the base band processor 107. On the basis of the acquired group call information, the inquiry processor 112 also displays the information as shown in FIG. 8 on the display unit 105b.

The received call history updating unit 113 updates the received call history stored in the memory 109 on the basis of the acquired group call information.

The halfway participation processor 114 performs a processing to participate in the group call halfway on the basis of the input signal from the operation unit 108.

Specifically, the halfway participation processor 114 generates a transmission request (INFO) of the call request (INVITE) to the mobile station 100 on the basis of the identification information of the participating mobile station stored as the received call history in the memory 109. The halfway participation processor 114 inputs the generated SIP information (INFO) into the base band processor 107.

Specifically, the halfway participation processor 114 generates the SIP information (180 Ringing, 200 OK, etc.) in accordance with the SIP information (call request (INVITE) from the participating mobile station) acquired from the base band processor 107. Then, the halfway participation processor 114 inputs the generated SIP information into the base band processor 107.

### (Method for Communication)

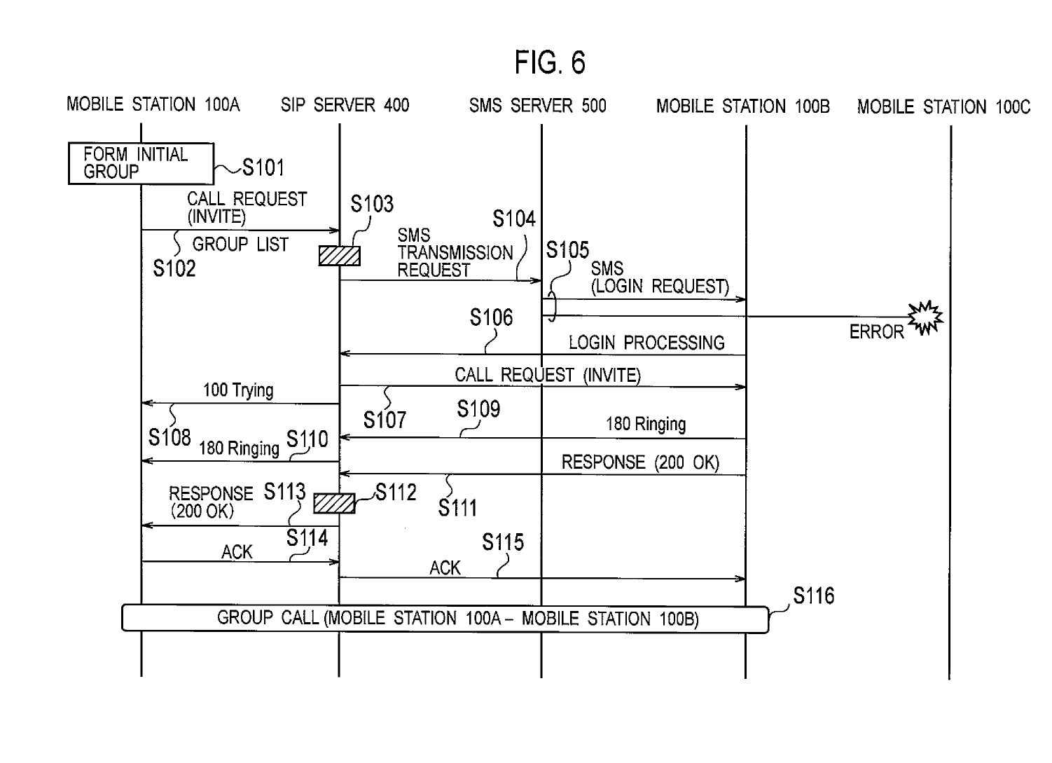

Hereinafter, with reference to FIGS. 6 to 8, a method for communication according to the present embodiment will be described.

First, with reference to FIG. 6, a processing to start the group call will be described when the mobile station 100A is the originating mobile station and the mobile stations 100A to 100C are the initial group.

As shown in FIG. 6, at Step S101, the mobile station 100A specifies the mobile stations 100B and 100C, and forms an initial group including the mobile stations 100A to 100C.

At Step S102, the mobile station 100A transmits the call request (INVITE), which is to call the mobile stations 100B and 100C, to the SIP server 400. The call request (INVITE) which is to call the mobile stations 100B and 100C includes the originating time and the identification information of the mobile stations 100A to 100C as mentioned above.

At Step S103, the SIP server 400 performs a processing to register the group call information in the group call management DB 410. Specifically, the SIP server 400 associates with each other and stores the above-mentioned identification information of the originating mobile station (identification information of the mobile station 100 A), the originating time, the identification information of the initial members (identification information of the mobile stations 100A to 100C), and the identification information of a member expected to participate (identification information of the mobile station 100A).

At Step S104, the SIP server 400 transmits the SMS transmission request to the mobile stations 100B and 100C, to the SMS server 500.

At Step S105, the SMS server 500 transmits the SMS (login request) to the mobile stations 100B and 100C. Here, the SMS (login request) transmitted to the mobile station 100C by the SMS server 500 results in a transmission error.

At Step S106, the mobile station 100B performs a login processing in the SIP server 400.

At Step S107, to the mobile station 100B, the SIP server 400 transmits the call request (INVITE), which is to call the mobile station 100B and which is received from the mobile station 100A.

At Step S108, the SIP server 400 transmits SIP information (100 Trying) to the mobile station 100A, the SIP information (100 Trying) showing that the call request (INVITE) has been transmitted to the mobile station 100B.

At Step S109, the mobile station 100B transmits SIP information (180 Ringing) to the SIP server 400, the SIP information (180 Ringing) showing that it is ringing.

At Step S110, the SIP server 400 transmits the SIP information (180 Ringing) received at Step S109 to the mobile station 100A.

At Step S111, to the SIP server 400, the mobile station 100B transmits SIP information (200 OK) that shows a response. Here, the SIP information (200 OK) includes the identification information of the mobile station 100B.

At Step S112, the SIP server 400 performs an update processing of the group call information to the group call management DB 410. Specifically, the SIP server 400 adds the identification information of the mobile station 100B to the identification information of the participating members registered at Step S103 (identification information of the mobile station 100B).

At Step S113, the SIP server 400 transmits the SIP information (200 OK) received at Step S111 to the mobile station 100A.

At Step S114, the mobile station 100A transmits SIP so information (ACK) to the SIP server 400.

At Step S115, the SIP server 400 transmits the SIP information (ACK) received at Step S114 to the mobile station 100B.

At Step S116, the group call is started where the mobile stations 100A and 100B are the participating mobile stations. Here, the mobile station 100C is the non-participating mobile station.

Although not shown, the non-participating mobile station also includes the mobile station that cannot perform the login processing to the SIP server 400 even when receiving the SMS (login request), and the mobile station that does not respond even when receiving the call request (INVITE).

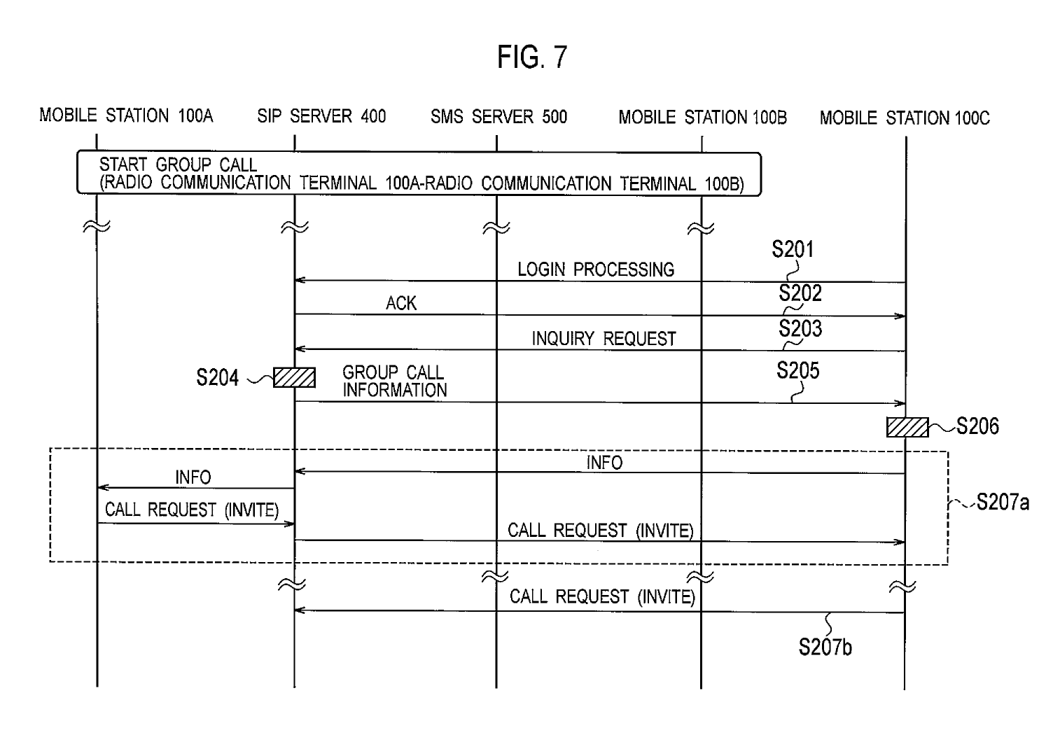

Secondly, with reference to FIGS. 7 and 8, processing will be described in which the mobile station 100C that is the non-participating mobile station inquires the information on the group call that includes the mobile station 100C in the initial group.

As shown in FIG. 7, at Step S201, the mobile station 100C performs the login processing in the SIP server 400, in response to an instruction to start an inquiry processing by a user of the mobile station 100C.

At Step S202, the SIP server 400 transmits the SIP information (ACK) to the mobile station 100C, the SIP information (ACK) showing that the login processing is successful.

At Step S203, the mobile station 100C transmits the inquiry request to the SIP server 400, the inquiry request including the identification information of the mobile station 100C.

At Step S204, with reference to the group call management DB 410, the SIP server 400 extracts the identification information of the originating mobile station, the originating time, the identification information of the initial members, the identification information of the participating members, and the group call status that are associated with the identification information of the initial member that coincides with the identification information of the mobile station 100C.

For example, when the information shown in FIG. 3 is stored in the group call management DB 410, the SIP server 400 extracts group call information G1 to G3, on the basis of the identification information of the mobile station 100C.

At Step S205, the SIP server 400 transmits the group call information extracted at Step S204 to the mobile station 100C.

At Step S206, the mobile station 100C updates the received call history stored in the memory 109 on the basis of the received group call information.

On the basis of the received group call information, the mobile station 100C generates a display screen as shown in FIG. 8. Here, with reference to FIGS. 3 and 8, the display screen that the mobile station 100C generates on the basis of the group call information will be described. The group call information G1 to G3, the identification information G11 and G31 of the originating mobile station, the originating time G12, the identification information G13 of the initial members, the identification information G14 of the participating members, and the group call status G35 shown in FIG. 3 respectively correspond to those shown in FIG. 8.

As shown in FIG. 8(a), the mobile station 100C generates the display screen that displays the group call information G1 to G3 in order of the originating time. For example, in the group call information G1, the user name and the originating time G12 associated with the identification information G11 of the originating mobile station are displayed. As shown in the group call information G3, the telephone number associated with the identification information G31 of the originating mobile station and information G35 showing a terminated group call may be displayed.

The user name is displayed with reference to the address book stored in the memory 109 of the mobile station 100C.

When the user of the mobile station 100C performs operation to select the group call information G1 and an area A1 (details) in the display screen shown in FIG. 8(a), the display screen changes to the one shown in FIG. 8(b) or FIG. 8(c).

The display screen shown in FIG. 8(b) displays the user name associated with the identification information of the initial members G13 and information G14 showing the participating members.

The display screen shown in FIG. 8(c) displays only the user name associated with the identification information of the participating members G14.

When the user of the mobile station 100C performs operation to select the group call information G1 that is information on an on-going group call and an area A2 (participation) in the display screen shown in FIG. 8(a), and when the user of the mobile station 100C performs operation to select an area A3 (participation) or an area A4 (participation) in the display screen shown in FIG. 8(b) or FIG. 8(c), the display screen changes to the one shown in FIG. 8(d).

The display screen shown in FIG. 8(d) displays information for inquiring the user of the mobile station 100C whether to participate in the group call halfway. Here, when the user of the mobile station 100C performs operation to select an area A5 (participation) that shows halfway participation in the group call, the processing goes to Step S207a of FIG. 7.

As shown in FIG. 7, at Step S207a, the mobile station 100C transmits the transmission request (INFO) of the call request (INVITE), which is to call the mobile station 100C, to the mobile station 100A. The mobile station 100A, which receives the transmission request (INFO) of the call request (INVITE) which is to call the mobile station 100C, transmits the call request (INVITE) which is to call the mobile station 100C to the SIP server 400. The mobile station 100C, which receives the call request (INVITE) which is to call the mobile station 100C from the SIP server 400, responds to the SIP server 400 (200 OK) and participates in the group call halfway.

On the other hand, when the user of the mobile station 100C performs the operation to select the group call information G3 of the terminated group call and the area A2 (participation) in the display screen shown in FIG. 8(a), the display screen changes to the one shown in FIG. 8(e).

The display screen shown in FIG. 8(e) displays the information for inquiring the user of the mobile station 100C whether to restart the group call with the initial members of the terminated group call.

Here, when the user of the mobile station 100C performs operation to restart the group call with the initial members of the terminated group call, the processing goes to Step S207b of FIG. 7.

As shown in FIG. 7, at Step S207b, a call request (INVITE) to the mobile stations other than the mobile station 100C included in the initial group of the terminated group call is transmitted to the SIP server 400, thereby to newly originate (start) a group call.

### (Effects and Advantages)

According to the radio communication network and the communication method according to the present embodiment, the SIP server 400 (server) has the group call management DB 410 configured to store the identification information of the initial members (initial group mobile stations) and the identification information of the participating members (participating mobile stations). Moreover, on the basis of the identification information of the mobile station 100C transmitted from the mobile station 100C (non-participating mobile station), from the group is call management DB 410, the SIP server 400 extracts the identification information of the participating mobile stations that participates in the group call including the mobile station 100C in the initial group.

Therefore, even the mobile station 100C (non-participating mobile station), which does not participate in the group call, can acquire the identification information of the participating mobile station that participates in the group call including the mobile station 100C in the initial group by transmitting the identification information of the mobile station 100C.

In the radio communication network and the communication method according to the present embodiment, in response to halfway participation in the group call by the non-participating mobile station or the mobile station not included in the initial group, and withdrawal from the group call by the participating mobile station, the identification information of the participating mobile station stored in the group call management DB 410 is updated.

Thus, even in the group call where the participating mobile stations replace, the mobile station 100C can easily figure out the participating mobile stations.

Additionally, according to the radio communication network and the communication method according to the present embodiment, the mobile station 100C stores the group call information acquired from the SIP server 400 as the received call history.

Therefore, even when the mobile station 100C is located out of the area of the line switching network or the area of the packet switching network and thus cannot receive the call request (INVITE) from the mobile station 100A (originating mobile station) at the time when the group call including the mobile station 100C in the initial group is started, the mobile station can save the received call history of the group call that includes the mobile station 100C in the initial group.

Furthermore, on the basis of the received call history, the mobile station 100C can specify the participating mobile station to which the mobile station 100C has to transmit the transmission request (INFO) of the call request (INVITE) which is to call the mobile station 100C. The participating mobile station, which receives the transmission request (INFO) of the call request (INVITE) which is to call the mobile station 100C, transmits the call request (INVITE) which is to call the mobile station 100C. Thus, an invitation from the participating mobile station allows the mobile station 100C to participate in the group call halfway.

Additionally, on the basis of the received call history, the mobile station 100C generates the call request (INVITE) (start request) using the identification information of the mobile station other than the mobile station 100C included in the initial group of the terminated group call and calls. Thereby, the mobile station 100C can newly start a group call.

According to the radio communication network and the communication method according to the present embodiment, the mobile station 100C displays the group call information acquired from the SIP server 400.

Therefore, the user of the mobile station 100C can confirm the user of the participating mobile station that participates in the group call at present, and can determine whether to participate in the group call halfway. The user of the mobile station 100C can participate in the on-going group call halfway or can newly start the terminated group call in accordance with the display screen, thereby improving convenience for the user.

### Other Embodiments

While the case where the SIP is used as the communication protocol has been described in the present embodiment, the present invention will not be limited to the case. Any other communication protocol that can implement the above-mentioned operation of the embodiment can be applied to the present invention.

For example, in the above-mentioned embodiment, the case has been described where the inquiry request from the mobile station 100C is directly transmitted to the SIP server 400 using the message of the SIP or the like to the SIP server 400. However, the inquiry request from the mobile station 100C may be transmitted to the SIP server 400 through the SMS server 500, for example, using the short message service provided by the SMS server 500. Alternatively, the E-mail service or the like can be also used.

Similarly, the group call information transmitted by the SIP server 400 may also be transmitted using the short message service or the E-mail, rather than directly transmitted to the mobile station 100C.

While it has been described that the group call information transmitted by the SIP server 400 in the above-mentioned embodiment includes all of the identification information of the originating mobile station, the originating time, the identification information of the initial members, the identification information of the participating members, and the group call status, the group call information may be any one of these, or may be a combination of these.

In the above-mentioned embodiment, the servers provided in the radio communication network 1 are the SMS server 500 and the SIP server 400, but not limited to these. Specifically, in addition to the SMS server 500 and the SIP server 400, the radio communication network 1 may have a group call managing server configured to manage the group call. In this case, the group call management DB 410 provided for the SIP server 400 may be provided in the group call managing server.

Additionally, the definition of the group call is not limited to that in the above-mentioned example. For example, the definition of the group call can be also applied to the case where the mobile station that newly performs an addition request during the group call cannot participate or does not participate as in the above-mentioned example, and hence makes an inquiry later.

As mentioned above, although an example of the present invention has been described, it is only illustrated as a specific example, and does not particularly limit the present invention. A detailed configuration of each part can be designed or can be modified where relevant. A configuration of each embodiment and a configuration of each modified example also can be combined, respectively. The effects and advantages of each embodiment and each modified example only enumerate the most suitable effects and advantages resulted from the present invention, and the effects and advantages according to the present invention are not limited to what has been described in each embodiment and each modified example.

Entire contents of Japanese Patent Application No. 2006-124527 (filed on Apr. 27, 2006) are incorporated herein by reference.

### INDUSTRIAL APPLICABILITY

As mentioned above, the group call notification method and the mobile station according to the present invention allow even the non-participating mobile station that does not participate in the group call to figure out the participating mobile station of the group call including the non-participating mobile station in the initial group, and therefore, are useful in the mobile communications.

1. A group call notification method comprising the steps of:
managing, when a plurality of members are specified and a group call is started, information on a member participating in the group call among the specified members; and
notifying, when receiving an inquiry about a member participating in the group call from a member not participating in the group call among the specified members, the member who has made the inquiry of information related to the member participating in the group call on the basis of the managed information.

2. A mobile station comprising:
a transmitter configured to transmit an inquiry request that inquires whether a group call where the mobile station is specified is started, using identification information that identifies the mobile station;
an acquiring unit configured to acquire information related to the group call where the mobile station is specified, in response to the inquiry request transmitted by the transmitter; and
a display unit configured to display the information that is related to the group call where the mobile station is specified, and is acquired by the acquiring unit.

3. The mobile station according to claim 2, wherein
when a group call where the mobile station is specified is started, the acquiring unit acquires the information on a member participating in the group call as the information related to the group call where the mobile station is specified; and
the display unit displays the information on the member participating in the group call, the information being acquired by the acquiring unit.

4. The mobile station according to claim 2, wherein
the identification information that identifies the mobile station is any one of a telephone number, an e-mail address, and an IP address.

5. The mobile station according to claim 2, further comprising: a storage unit configured to store information of a received call history, wherein
the acquiring unit stores the information on the group call where the mobile station is specified in the storage unit as the received call history, the information being acquired in response to the inquiry request.

6. The mobile station according to claim 5, further comprising:
a calling unit configured to call by generating a start request of a new group call, using the information on the group call where the mobile station is specified, the information being stored in the storage unit as the received call history.
